(19) United States
(12) Patent Application Publication
(10) Pub. No.: US 2024/0050942 A1
(43) Pub. Date: Feb. 15, 2024

(54) MICROFLUIDIC DEVICE FOR TESTING AQUEOUS SAMPLES CONTAINING BIOMATERIALS

(71) Applicant: Colgate-Palmolive Company, New York, NY (US)

(72) Inventors: Carlo DAEP, Brooklyn, NY (US); Ayoub HBAICH, Franklin Park, NJ (US)

(73) Assignee: Colgate-Palmolive Company, New York, NY (US)

(21) Appl. No.: 18/257,819

(22) PCT Filed: Dec. 14, 2021
(86) PCT No.: PCT/US2021/063326

§ 371 Date: Jun. 15, 2023

Related U.S. Application Data
(60) Provisional application No. 63/125,538, filed on Dec. 15, 2020.

(51) Int. Cl. B01L 3/00

(52) U.S. Cl. CPC B01L 3/502715; B01L 3/5025; B01L 2300/0609; B01L 2300/0829; B01L 2300/123; B01L 2300/0877; B01L 2200/0689

(57) ABSTRACT

A device for testing aqueous laboratory samples in one embodiment includes a base member extending along a longitudinal axis and defining a plurality of sample chambers recessed in a first outer surface. A resiliently deformable first gasket is disposed on the first outer surface and comprises openings each corresponding to a respective one of the chambers. At least a first cover glass is disposed on the first gasket to enclose the openings. A peripheral clamping frame disposed on the first cover glass comprises resiliently flexible cantilevered locking protrusions configured to form a snap interlock with the base member and compress the first cover glass between the clamping frame and first gasket to seal the chambers. Some embodiments include a second resiliently deformable gasket compressed between the clamping frame and first cover glass. Fluid couplings associated with each chamber allow fluid to enter and exit the chambers.

### CROSS-REFERENCE TO RELATED APPLICATIONS

The present application claims priority to U.S. Provisional Patent Application Ser. No. 63/125,538, filed Dec. 15, 2020, the entirety of which is incorporated herein by reference.

### BACKGROUND

The present invention generally relates to devices used in laboratories, and more particularly to a microfluidic device usable for testing aqueous samples containing biomaterials and/or biological organisms.

Various testing devices and associated methods may be used for performing laboratory tests or assays on samples containing various biomaterials (biological organic materials) contained or supported in an aqueous solution. As non-limiting examples, such biomaterials can include hard or soft tissue and other materials extracted from humans and animals, and living organisms such as microbes or bacteria. Such testing devices may further be used to incubate or grow biomaterials such as biofilms. The biomaterials may be subjected to treatment regimens using various agents, chemicals, or drugs to evaluate their efficacy on the biomaterials. One field in which such testing devices may be used is oral care where the effectiveness of various oral care agents on biomaterials associated with the oral cavity is of particular interest.

Biomaterial testing devices generally include numerous individual substrates and parts which are formed individually, and then packaged and held together often via permanent irremovable fixation techniques to create sample testing cells or chambers. Such permanent constructions may therefore be difficult to clean and generally cannot be reused for conducting other tests. In addition, such testing devices may also be complex constructions difficult to assemble efficiently and expediently.

Improvements in biomaterial testing and growth devices are desired.

### BRIEF SUMMARY

The present application discloses a microfluidic testing device and system for biomaterials having a minimal number of parts, and which can be readily assembled and dissembled to access the testing chambers for cleaning and reuse. This advantageously avoids the necessity to discard the device after a single test run. In one embodiment, some or all of the components of the present testing device may be fabricated by 3D printing techniques, injection molding, and combinations thereof.

The microfluidic device for testing aqueous laboratory samples in one embodiment may include an elongated base member comprising a plurality of sample chambers recessed into a first outer surface of the base member. The chambers are configured for holding an aqueous solution containing biomaterial. A resiliently deformable first gasket is disposed on base member and comprises openings each of which are complementary configured to correspond to a respective one of the chambers. At least one first cover glass is disposed on the first gasket to enclose the openings. A perimetrically-extending peripheral clamping frame is disposed on the first cover glass and comprises resiliently flexible cantilevered locking protrusions. The locking protrusions are configured to form a snap interlock with the base member to compress the first cover glass between the clamping frame and first gasket which fluidly seals the chambers. Some embodiments may include a second resiliently deformable gasket compressed between the clamping frame and first cover glass for added sealing effectiveness. Certain embodiments include a pair of cover glasses sealed between the pair of gaskets.

Fluid couplings associated with each chamber allow fluids such as treatment fluids or drugs to enter and exit the chambers to interact with the biomaterial in the aqueous samples. In some embodiments, the first gasket may be formed by 3D printing directly onto the base member forming an integral part thereof which is irremovable. The second gasket may be formed by 3D printing directly onto the clamping frame forming an integral part thereof which is irremovable. This integral gasket construction avoids handling loose gasket materials and quickens assembly/disassembly of the testing device. The integral gasket construction advantageously extends the useful life of the testing device for performing numerous testing runs. The gaskets may be formed of a resiliently deformable and compressible silicon-like material capable of forming a liquid tight seal.

In one embodiment, without limitation, the present biomaterial testing device may be used to perform assays on aqueous samples containing biomaterials to evaluate the effectiveness of various oral care agents associated with the oral cavity. Other testing applications associated with other types of biomaterials may also used. As some non-limiting examples, the testing device may be used for anti-attachment assays, antibacterial/antimicrobial efficacy studies, biofilm community composition studies, anti-biofilm agents, metatranscriptome studies, metabolomic studies, occlusion studies, enamel hardness studies in response to biofilm growth, staining and whitening studies, mammalian cell studies, tissue co-culture studies, and tissue-biofilm co-culture studies to name a just a few. The current invention can have oral care, personal care, home care, and pet care applications, as well as other applications.

According to one aspect, a microfluidic device for testing aqueous laboratory samples comprises: a longitudinal axis; an elongated base member extending along the longitudinal axis and defining a first outer surface, an opposite second outer surface, and a plurality of sample chambers; a resiliently deformable first gasket disposed on the first outer surface, the first gasket comprising a plurality of openings each corresponding to a respective one of the sample chambers; at least a first cover glass disposed on the first gasket and enclosing the openings; and a peripheral clamping frame disposed on the first cover glass and comprising a plurality of resiliently flexible locking protrusions; wherein the locking protrusions are configured to form a mechanical coupling with the base member and compress the first cover glass between the clamping frame and first gasket to seal the sample chambers. In one embodiment, a snap fit or interlock is formed between the locking protrusions and the base member.

According to another aspect, a microfluidic system for testing aqueous laboratory samples comprises: a base member comprising a longitudinal axis, a plurality of sample chambers recessed into a first outer surface of the base member, and an integral resiliently deformable first gasket formed on the first outer surface; each of the sample chambers comprising an inlet port and an outlet port defining a flow path through each of the sample chambers for introducing and extracting a fluid; the first gasket comprising a plurality of openings each corresponding to a respective one of the sample chambers; a first cover glass and a second cover glass each disposed on the first gasket and enclosing the openings; a peripheral clamping frame comprising an integral second gasket formed on an underside thereof, the second gasket engaging the first and second cover glasses, the clamping frame further comprising a plurality of resiliently flexible locking protrusions; wherein the locking protrusions are configured to form a mechanical coupling with the base member and compress the first cover glass between the clamping frame and first gasket to seal the sample chambers. In one embodiment, a snap fit or interlock is formed between the locking protrusions and the base member.

According to another aspect, a method for assembling a microfluidic device for testing aqueous laboratory samples comprises: providing an elongated base member comprising a longitudinal axis, a plurality of sample chambers recessed into a first outer surface of the base member, and a resiliently deformable first gasket disposed on the first outer surface; positioning at least a first cover glass on the first gasket; positioning a clamping frame over the first cover glass; slideably engaging a plurality of resiliently flexible locking protrusions of the clamping frame with the base member, the locking protrusions being in a deflected outward position; and lockingly engaging the locking protrusions with the base member, the locking protrusions moving to an undeflected inward position; wherein the clamping frame compresses the first cover glass onto first gasket to seal the sample chambers. In one embodiment, the slideably engaging step includes engaging and sliding hooked ends of each locking protrusions along sides of the base member which moves the locking protrusions to the deflected outward position. In the same or other embodiments, the lockingly engaging step further comprises engaging the hooked ends of the locking protrusions with a second surface of the base member opposite the first surface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The features, and advantages of the invention will be apparent from the following more detailed description of certain embodiments of the invention and as illustrated in the accompanying drawings in which:

FIG. 1 is a top perspective view of a laboratory sample testing device according to one embodiment of the present disclosure comprising an assembly including a base member containing sample chambers, lower sealing gasket, cover glasses, upper sealing gasket, and clamping frame;

FIG. 2 is a bottom perspective view thereof;

FIG. 3 is an exploded view thereof;

FIG. 4 is a side elevation view of a first longitudinal side thereof;

FIG. 5 is a side elevation view of a second longitudinal side thereof;

FIG. 6 is an end view of a first lateral end or side thereof;

FIG. 7 is an end view of a second lateral end or side thereof;

FIG. 8 is a top view thereof;

FIG. 9 is a bottom view thereof;

FIG. 10 is a longitudinal cross section view thereof;

FIG. 11 is a transverse cross-sectional view thereof;

FIG. 12 is a side view of a clamping frame with integral upper gasket of the device of FIG. 1;

FIG. 13 is a top view thereof showing the peripheral body of the clamping frame in phantom lines to better show the gasket;

FIG. 14 is a longitudinal cross-sectional perspective view thereof;

FIG. 15A is a top view of a first embodiment of the upper gasket comprising a pair of gasket segments;

FIG. 15B is a side view thereof;

FIG. 16A is a top view of a second embodiment of the upper gasket having a one-piece body;

FIG. 16B is a side view thereof;

FIG. 17 is a side view of the clamping frame without the upper gasket in place;

FIG. 18 is a top view thereof;

FIG. 19 is a bottom perspective view thereof;

FIG. 20 is a lateral end or side view of the testing device of FIG. 1 showing an alternative configuration of hose bars used to provide fluid coupling to the sample chambers; and

FIGS. 21A, 21B, and 21C respectively show a transverse cross section, longitudinal cross section, and top view of the sample chambers incorporating optional sample holders.

All drawings are schematic and not necessarily to scale. Features numbered in some views but not in others are the same features unless expressly noted otherwise herein.

### DETAILED DESCRIPTION

The following description of the illustrative embodiment(s) is merely exemplary (example) in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

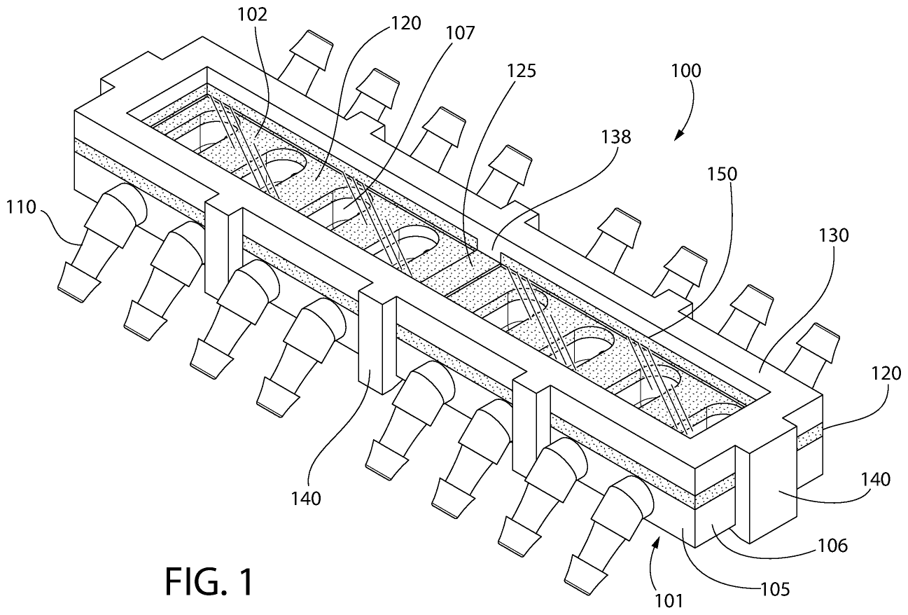

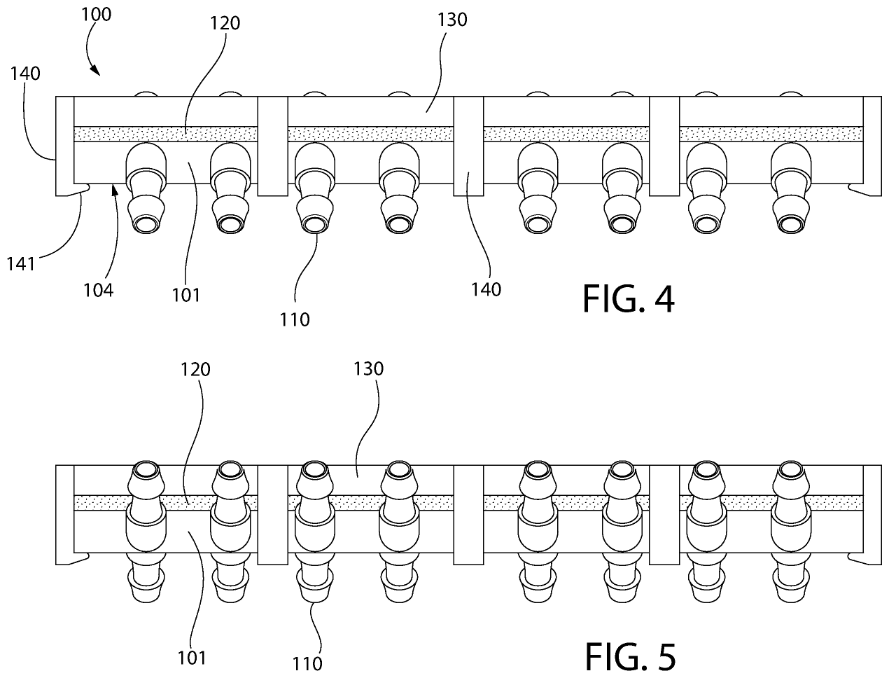

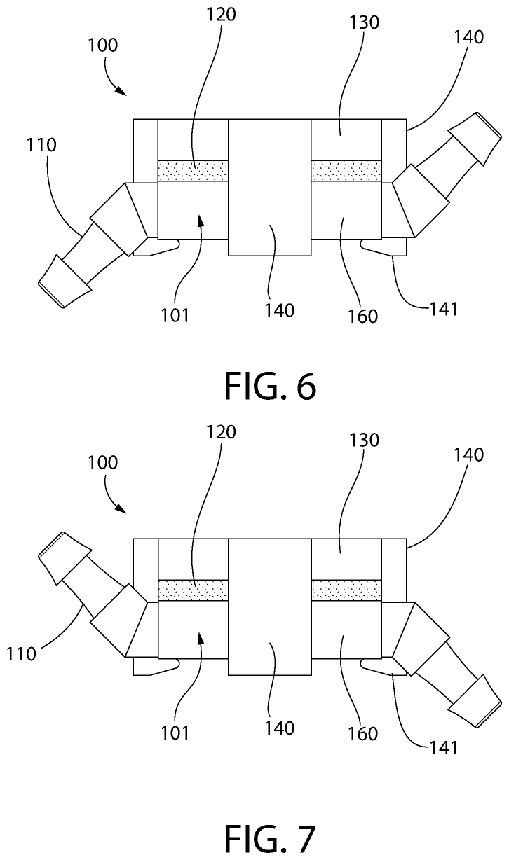

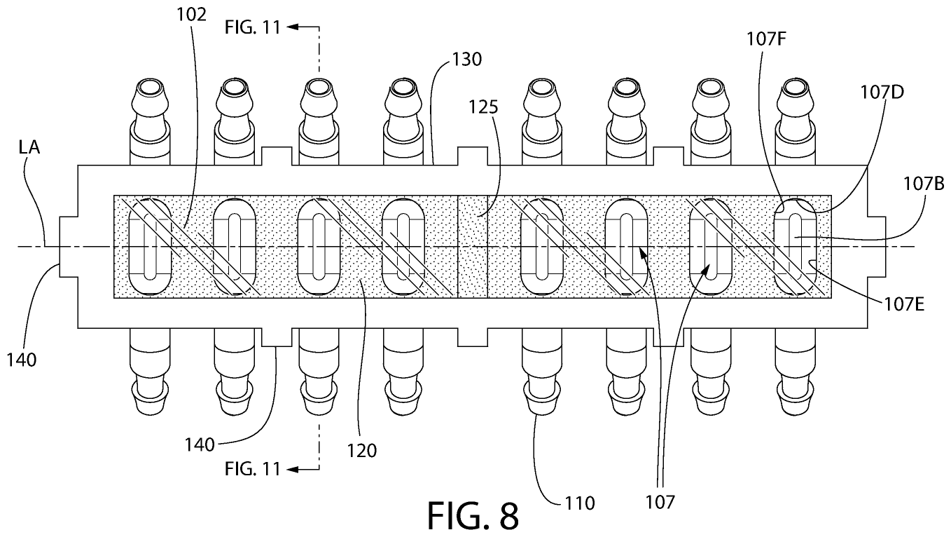

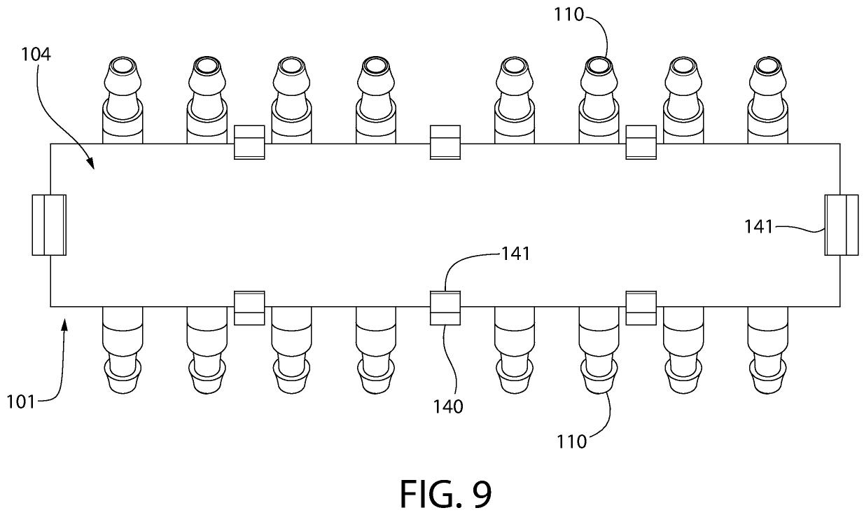

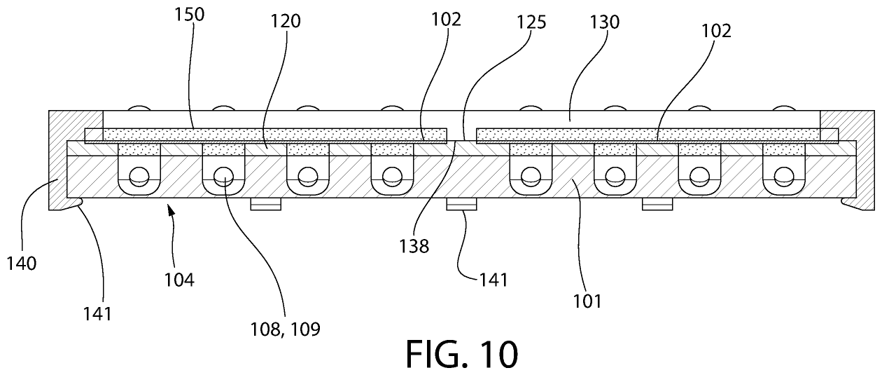

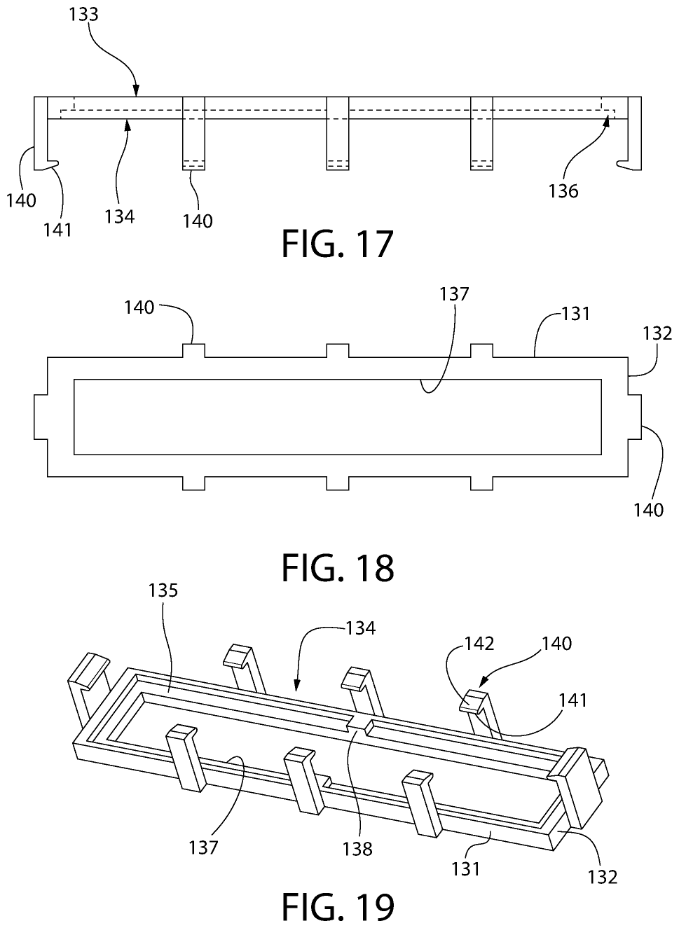

Referring to FIGS. 1-19, a microfluidic testing device 100 and various parts thereof according to the present disclosure is shown. For convenience of description and reference only, the device is shown in a horizontal position or orientation as it may be for ease of assembly. Although the device may be used in this position for testing, the device may be used in any other suitable orientation such as vertically or at an angle between vertical and horizontal for testing. Accordingly, the microfluidic testing device is not limited to use in the horizontal position alone.

Microfluidic testing device 100 generally includes (in packaged order) a base member 101, a lower gasket 120 on the base member, at least one transparent cover slip or glass 102, an upper gasket 150, and a clamping frame 130 configured to engage and interlock with the base member. In some embodiments, a pair of cover glasses as shown in the figures may be used.

Base member 101 has an axially elongated body defining a longitudinal axis LA of the device, an upper outer surface 103, an opposite lower outer surface 104, lateral ends or sides 106 oriented transversely to axis LA, and longitudinal sides 105 extending axially along axis LA between the lateral sides. Longitudinal sides 105 have a greater length than the lateral sides. Each of the longitudinal sides and each of the lateral sides may be parallel to each other respectively as shown giving the base member and testing device 100 an overall rectangular configuration. Other polygonal and non-polygonal configurations however may be used. The outer surfaces 103, 104 may be parallel to each other and may be generally flat. Outer surfaces 103, 104 represent major surfaces each having a greater surface area than the longitudinal or lateral sides.

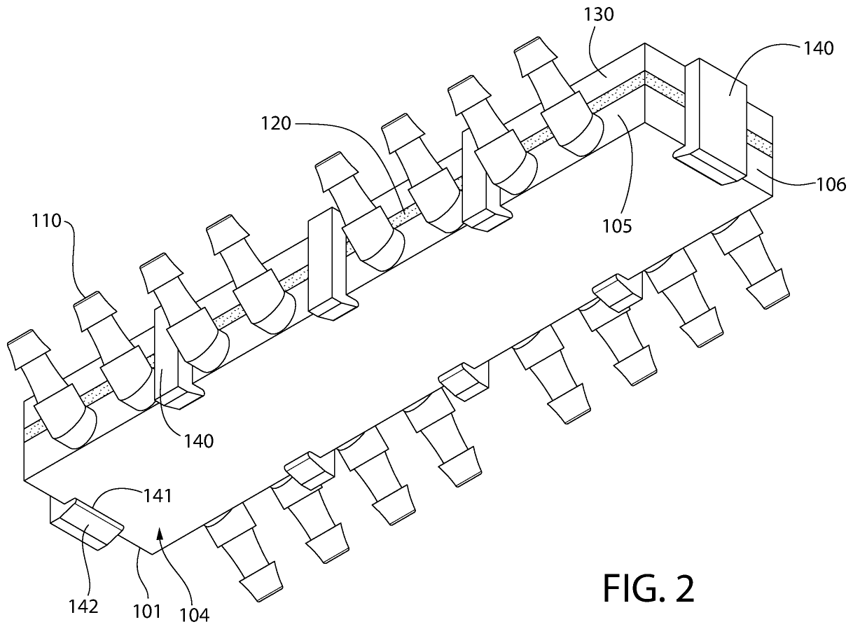

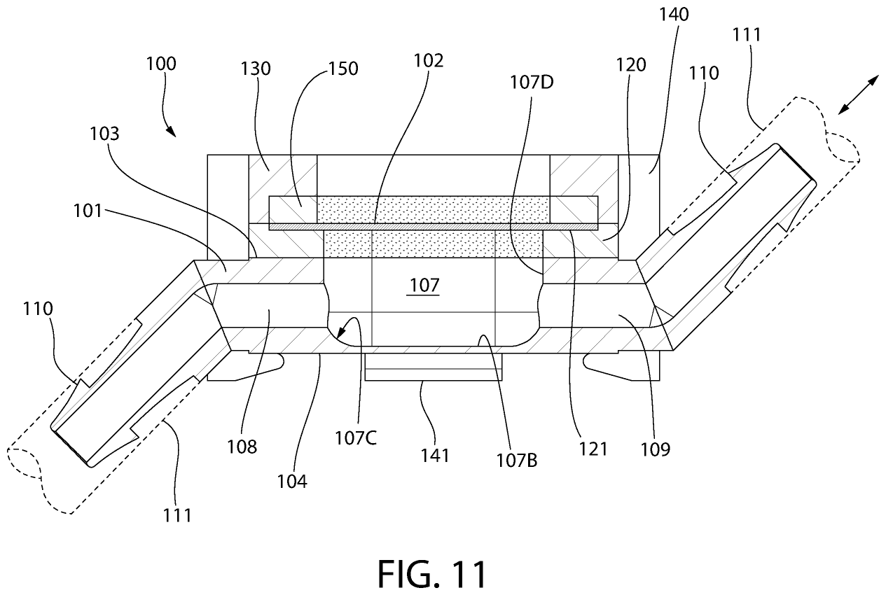

Base member 101 further includes a plurality of outwardly open sample cells or chambers 107 recessed into upper outer surface 103. Chambers 107 are longitudinally spaced apart and may be elongated in shape in a direction transverse (e.g., perpendicularly) to longitudinal axis LA and longitudinal sides 105 of the base member. In one embodiment, chambers 107 may be oval in shape having rounded ends. The chambers may extend only partially through the thickness of the base member and therefore do not penetrate the second outer surface 104 (see, e.g., FIGS. 2 and 11). Chambers 107 therefore have an open top 107A and closed floor or bottom 107B in one non-limiting embodiment.

To avoid accumulation of biofilm or other deposits, and provide efficient removal of toothpaste slurries as well as reduce biofilm accumulations and facilitate cleaning the sample chambers 107 between uses, the chambers are arcuately contoured to eliminate stagnant flow areas and sharp corner areas. Accordingly, in one embodiment, the transition 107C between long sidewalls 107E and short end walls 107D with the bottom wall 107B may be arcuately rounded or radiused rather than formed by sharp 90 degree transition or intersection. Similarly, the vertical intersection at the four corners 107F between the sidewalls 107E and end walls 107D may similarly be arcuately rounded or radiused. These measures eliminate sharp corners where flow can stagnate and concomitantly accumulations can occur.

Base member 101 further includes a pair of fluid exchange ports 108, 109 associated with each sample chamber 107. Ports 108, 109 are fluidly coupled to each chamber and extend in a transverse direction (e.g., perpendicularly) to longitudinal axis LA. The ports may penetrate the longitudinal sides 105 of the base member. In one non-limiting embodiment, as illustrated, the ports 108, 109 are located on opposite lateral sides of and penetrate each sample chamber 107 to define a fluid path therethrough. Depending on the testing procedures used, the ports 108, 109 may each be considered and used as inlet or outlet ports (see, e.g., FIG. 11 directional fluid flow arrows).

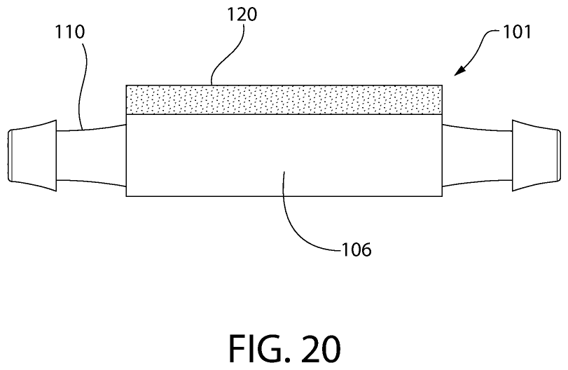

Base member 101 further includes a plurality of hose barbs 110. The hose barbs 110 are elongated fluid connection structures which define an internal flow conduit with circular cross section. Hose barbs 110 may be disposed on each of the longitudinal sides 105 of the base member adjacent a sample chamber 107 and project laterally outwards from sides in a general direction transverse to the longitudinal axis LA of the testing device. Each hose barb 110 is fluidly coupled to a fluid exchange port 108 or 109. The hose barbs 110 are configured to detachably couple flow conduit such as flexible tubing 111 (represented schematically by dashed lines) thereto for introducing and/or extracting fluid and aqueous solutions to each sample chamber 107 via the fluid exchange ports. Hose barbs 110 may have various orientations included angled as shown in FIG. 11 (i.e., at an oblique angle to outer surfaces 103, 104 of base member 101), or straight as shown in FIG. 20 (i.e., parallel to outer surfaces 103, 104). Regardless of orientation, the hose barbs may be oriented parallel to each other at least on the same longitudinal side of the base member 101. In some embodiments, the hose barbs 110 may straight on one longitudinal side 105, and angled on the opposite longitudinal side depending on the arrangement of tubing 111. Hose barbs 110 may be integrally formed by 3D printing or injection molding as monolithic unitary structural parts of the base member 101 in some embodiments. This eliminates potential leakage between the hose barb fluid couplings and the main body of the base member if each were formed separated and then connected such as via adhesives.

Lower gasket 120 is longitudinally elongated and may have a length and width which may be coextensive with the base member 101. Accordingly, gasket 120 in certain embodiments covers the entire upper outer surface 103 of the base member. Gasket 120 may thus have a rectangular body in some embodiments which includes a recessed upper surface 123 surrounded by a peripheral raised lip 126 extending perimetrically around the gasket, opposing lower surface 124, and a plurality of elongated openings 122 formed through the upper and lower surfaces. The openings 122 each correspond in configuration and location to a respective one of the sample chambers 107 being concentrically aligned therewith. Accordingly, openings 122 are complementary configured to the chambers 107 having an oval shape in the non-limiting depicted embodiment. Openings 122 create a direct line of sight into the sample chambers 101.

In one embodiment as illustrated where a pair of cover glasses 102 are provided, gasket 120 may include a raised partition wall 125 extending transversely and perpendicularly to the longitudinal axis LA at the midpoint of the length of the gasket. This results in two recessed areas 127; each of which receives a cover glass 102. When the cover glasses are positioned in their respective recessed areas, the cover glasses may not protrude upward beyond the peripheral raised lip 126, or slightly above in certain embodiments. In embodiments where a single cover glass might be used, the partition wall 125 may be omitted forming a contiguous single recessed area 127 from end to end of the gasket.

In one embodiment, lower gasket 120 may be formed of resiliently deformable rubber-like material having mechanical properties similar to silicon and which possesses an elastic memory. Suitable elastomeric gasket materials which may be used for example (without limitation) may have a tensile strength of about and including 2.4-5.5 MPa, compressive strength of about and including 10-30 MPa, tear strength of about and including 9-55 kN/m, and elongation at break of about and including 90-1120%. Representative commercially-available materials which may be used include Agilus 30 a PolyJet Photopolymer from Stratasys of Los Angeles, California, Flexible 80A Resin from Formlabs of Somerville, Massachusetts, and others. In one embodiment, lower gasket 120 may be formed directly on upper surface 103 of base member 101 via 3D printing (additive manufacturing). Accordingly, gasket 120 may be integrally formed on the first outer surface of the base member via this fabrication method becoming an irremovable permanent part of the base member. This fabrication method provides an efficient and cost effective way to form the gasket with precise control over thickness and features (e.g., holes 122, raise lip 126, etc.). In one non-limiting embodiment, gasket 120 may have a representative thickness of about 0.25 cm. Other suitable thicknesses may be used. In other possible embodiments, lower gasket 120 may be a separately formed discrete component which may be at least semi-permanently affixed to base member 101 such as via adhesives.

Cover glass 102 may be any suitable laboratory type cover glass/coverslip formed of transparent glass, plastic, or other material. The term “glass” as used here is simply therefore a shorthand for a term of art including any of these materials which is expressly not limited to glass alone. Each cover glass 102 is configured to fit within one of the recessed areas 127 of lower gasket 120 previously described herein. The cover glass preferably has a thickness not greater than the height of the raised lip 126 of the lower gasket such that the outward facing or upper surface of the glass does not protrude above the raise lip. The lower surface of the cover glass is sealed against the lower gasket 120.

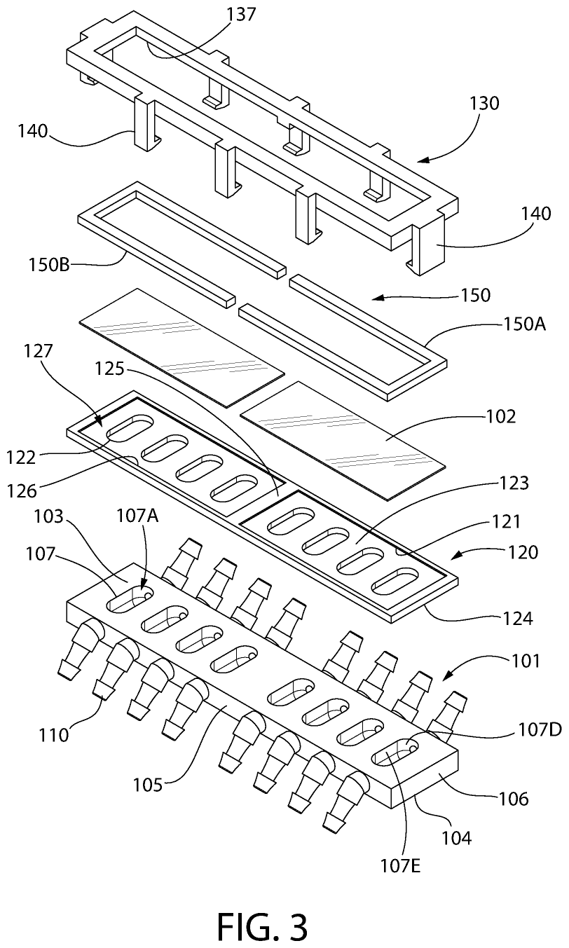

With particular reference to FIGS. 3 and 12-19 now, peripheral clamping frame 130 may be longitudinally elongated having a length and width which may be at least coextensive with the base member 101 and lower gasket 120 thereon. Accordingly, the clamping frame in certain embodiments extends perimetrically around and sealed against the peripheral-most portions of the lower gasket 120 (e.g., raised lip 126) as best shown in FIG. 11. Clamping frame 130 is configured to detachably engage and interlock the base member 101 to sandwich the cover glass 102, lower gasket 120, and base member 101 together.

Clamping frame 130 comprises a perimetrically extending and rectangular peripheral body which defines an axially elongated central window 137, and an upper gasket 150. Window 137 extends along longitudinal axis LA and the length of the testing device 100 when the clamping frame is mounted thereon. Window 137 provides a direct line of sight through the cover glasses 102 and into the sample chambers 107 of the base member 101 for confocal microscopy or other testing/examination techniques focused on the aqueous samples or materials in the chambers.

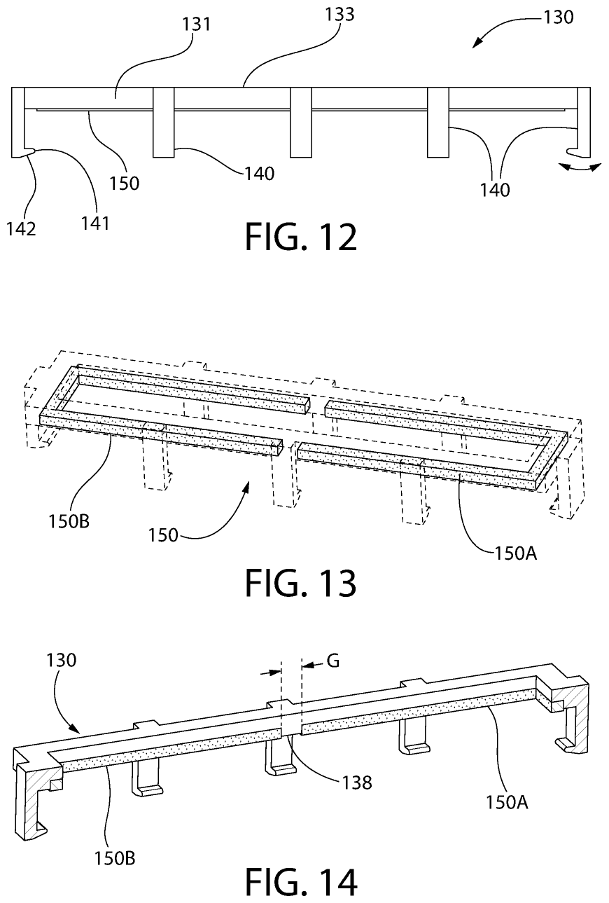

The peripheral body of clamping frame 130 is formed by an opposing pair of longitudinal walls 131, lateral end walls 132 extending transversely therebetween, and an upper surface 133 and opposite lower surface 132 defined by the longitudinal and end walls. The lower surface 132 of the frame may include a step feature 136 which defines a perimetrically extending gasket seating surface 135 on the underside of the clamping frame facing the base member 101. Gasket seating surface 135 faces downwards and inwards towards base member 102 and may be contiguous in structure extending perimetrically along the longitudinal walls 131 and lateral end walls 132 to circumscribe a majority or all of entire central window 137 depending on whether one or two cover glasses 102 are to be accommodated by the clamping frame 130 as further explained herein. The gasket seating surface 135 and hence upper gasket 150 may be at least partially recessed into the underside or bottom surface of the clamping frame such that a portion of the gasket projects outwards and downwards below the longitudinal walls 131 and end walls 132 of the frame (see, e.g., FIGS. 12-14). In other certain embodiments, the gasket 150 may be fully recessed into the underside of the frame 130 without any projection below the frame.

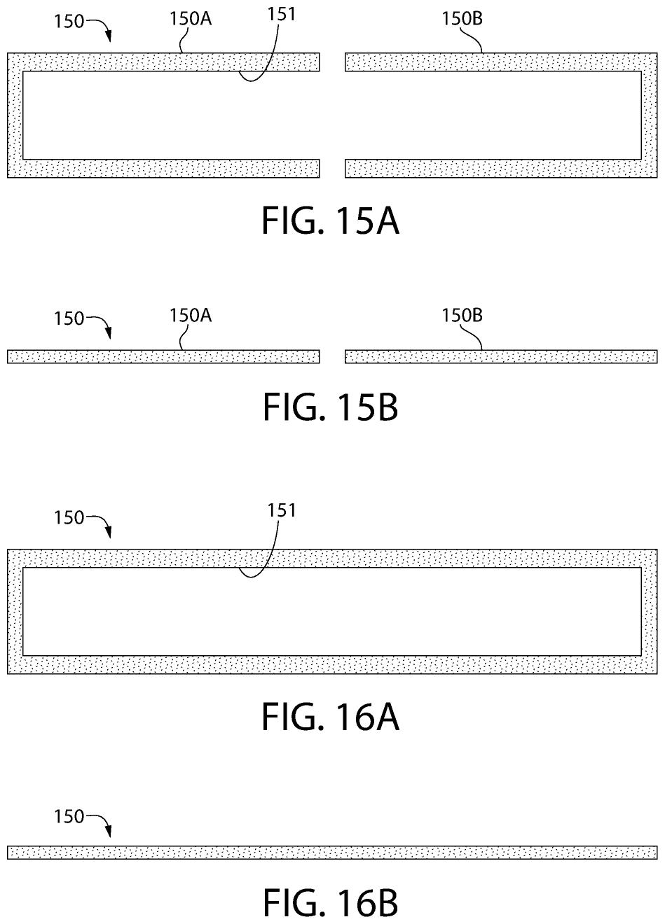

In one embodiment where two cover glasses 102 are provided, the upper gasket 150 may comprise a first segment 150A and a second segment 150B. Each segment may have a U-shaped body and are flat structures (FIGS. 15A-B); each segment defining a portion of a longitudinally elongated central window 151 which extends along the length of the testing device 100. Window 151 is vertically aligned with the corresponding window 137 defined by the peripheral body of the clamping frame 130, thereby creating a direct line of sight into the sample chambers 107 through the cover glasses 102.

When integrated into clamping frame 130 (with continued reference to FIGS. 12-19), the upper gasket segments 150A, 150B may be separated by a longitudinal gap G created by a pair of spacers 138 formed on the bottom surface 134 or underside of the clamping frame 130 (i.e., longitudinal walls 131). Spacers 138 may be located mid-length on the frame 130. When the testing device 100 is assembled as shown in FIGS. 3 and 11, the bottom surfaces of the gasket 150 (i.e., segments 150A, 150B in this case) seal each cover glass 102 along both the longitudinal upper peripheral surface portions and the lateral upper end peripheral surface portions of the cover glasses. The spacers 138 engage and seal against the lateral end portions of the elastomeric partition wall 125 formed by the resiliently deformable lower gasket 120 (see also FIG. 1).

It bears noting that in certain embodiments, the peripheral frame spacers 138 may be omitted and the upper gasket 150 may have a contiguous rectangular peripheral body that circumscribes a single contiguous central window 151 (see, e.g., FIGS. 16A-B). Such a construction can be used whether a single or two cover glasses 102 are provided for the testing device 100. The partition wall 125 of lower gasket 120 is omitted in the event a single cover glass 102 is used.

The upper gasket 150 in some embodiments may be formed of the same material as lower gasket 120 previously described in detail. According gasket 150 may be a resiliently deformable rubber-like material having mechanical properties similar to silicon and which possesses an elastic memory. In one embodiment, upper gasket 150 may be formed directly on the inward/downward facing gasket seating surface 135 of clamping frame 130 via 3D printing (additive manufacturing). Accordingly, gasket 150 may be integrally formed on the seating surface 135 via this fabrication method becoming an irremovable permanent part of the base member. In one non-limiting embodiment, gasket 150 (e.g., segments 150A, 150B) may have a representative thickness of about 0.35 cm. Each segment may be approximately 6 cm in length. Other suitable thicknesses and lengths may be used. In other possible embodiments, the upper gasket segments 150A, 150B may be separately formed discrete components each which may be at least semi-permanently affixed to base member 101 such as via adhesives.

Referring generally to FIGS. 1-19, and more particularly to FIGS. 12-14 and 17-29, clamping frame 130 further comprises a plurality of elongated and resiliently flexible locking protrusions 140. The locking protrusions may be formed integrally with the longitudinal walls 131 and lateral end walls 132 of the peripheral clamping frame in some embodiment a shown. Each wall 131, 132 includes at least one locking protrusion 140. A plurality of locking protrusions may be arranged in longitudinally spaced apart relation on the longitudinal walls 131 for better sealing of the cover glass(es) 102 as shown in one embodiment since these walls have a greater length than the lateral end walls 132. This provided relatively uniform clamping pressure against the cover glass(es) along its peripheral side portions.

Locking protrusions 140 of clamping frame 130 may be considered to form of elongated arms or legs of the frame which extend downwardly below the longitudinal and lateral end walls 131, 132 in a vertically inward direction towards base member 101 when the testing device 100 is assembled. The thickness of the locking protrusions 140 measured in an outward direction from the longitudinal and lateral end walls 131, 132 may be smaller than the width of the protrusions. This structures the locking protrusions to be more flexible and deflectable in vertical plane perpendicular to the longitudinal and lateral end walls (main body of the clamping frame 130) than in a vertical plane parallel to the walls for assembling the microfluidic testing device unit. The locking protrusions may further project laterally and longitudinally outward from the longitudinal walls 131 and lateral end walls 132 respectively as shown. This provides vertical sides of the testing device 100 in which the longitudinally and laterally exposed side or outer surfaces of the base member 101, lower and upper gaskets 120 and 150, and clamping frame 130 which are flush with respect to each other (see, e.g., FIGS. 1, 2, and 11). This contributes in a positive manner to forming leak-resistant and uniform sealing of the cover glasses 102 in the testing assembly.

Locking protrusions 140 may be located between the hose barbs 110 on the longitudinal sides 105 of the base member in one embodiment. The locking protrusions 140 are configured to form a detachable mechanical coupling or fit to the base member 101 such as via a snap interlock fit, friction or inference fit, or other type mechanical coupling. The locking protrusions 140 may have a length which extends below the bottom surface 104 of base member 101 when clamping frame 130 is coupled to the base member. One end of the locking protrusions 140 is fixed and formed integrally with clamping frame walls 131, 132 as a monolithic unitary part thereof. In one non-limiting embodiment, opposite ends 141 of the locking protrusions are each terminated with a hook which projects in an inward direction. The hooked ends 141 are configured to engage the underside (i.e., bottom surface 104) of the base member 101 to form a snap interlock fit therewith (see, e.g., FIGS. 2, 6-7, and 9-11). This creates a mechanical interlock coupling the clamping frame to the base member in a detachable manner, thereby advantageously allowing the testing device 100 to be readily disassembled for cleaning and reuse.

The hooked ends 141 of each locking protrusion 140 may include a sloped or angled leading surface 142 arranged to slideably engage the peripheral sides and ends of the lower gasket 120. This facilitates sliding the locking protrusions along and over the base member 101 and lower gasket 120. The resiliently flexible locking protrusions 140 are deflectable and movable laterally or longitudinally inward towards the testing device 100 and clamping frame 130, or longitudinally\laterally away therefore. Locking protrusions 140 are movable between a normal inward undeflected position, and an outward deflected position moved outwards away from the device 100 and clamping frame 130 during the process of attaching the clamping frame 130 to the base member 101.

When the testing device is assembled, the clamping frame 130 is positioned over and then moved/pushed vertically downwards (i.e., perpendicularly to longitudinal axis LA irrespective of the assembly orientation) onto the lower gasket 120 and base member 101. The leading surfaces 142 on the hooked ends 141 of the frame locking protrusions 140 initially contact and slideably engage the lower gasket 120, which deflects the locking protrusions 140 outwards to assume the deflected position (see directional movement arrows, FIG. 12). The leading surfaces of the locking protrusions continue to progress and slide downward on lower gasket 120 to next engage the longitudinal and lateral sides 105, 106 of base member 101. Once the hooked ends 141 pass below the bottom surface 104 of the base member, the locking protrusions 140 snap back inwards due to their elastic memory to the normal undeflected position, thereby engaging the hooked ends 141 with the underside (i.e., bottom surface 104) of the base member 101. This locks the entire testing device assembly together via the interlock formed between the clamping frame 130 and base member 101. The cover glasses 102 are now sandwiched between the base member 101 with its gasket 120 and clamping frame 130 with its gasket 150, and fluidly sealed in place in a liquid tight manner. While the locking protrusions 140 remain in this undeflected position, the clamping frame 130 cannot be vertically withdrawn or removed from the base member 101 and the lower gasket 120, thereby preventing disassembly of the testing device 100. For disassembly, the locking protrusions 140 may be moved to the deflected position so that the hooked ends 141 disengage the base member 101, thereby allowing the clamping frame 130 to be removed in a reverse manner to that described above.

A method for assembling a microfluidic device for testing aqueous laboratory samples may be summarized as first providing the elongated base member 101 containing a plurality of sample chambers 107 recessed into the upper outer surface 103 of the base member. Resiliently deformable lower gasket 120 is disposed on the outer surface 103, being integrally formed therewith such as via 3D printing in one non-limiting embodiment. The method continues with positioning at least a first cover glass 102 on the gasket 120, or a pair of cover glasses 102. The method continues with next positioning clamping frame 130 over the first or pair of cover glasses 102. The next step comprises slideably engaging the plurality of resiliently flexible locking protrusions 140 of the clamping frame 130 with the base member 101; the locking protrusions moving to and being in the deflected outward position. The method continues with lockingly engaging the locking protrusions with the base member; the locking protrusions returning and moving to the initial undeflected inward position. The clamping frame compresses the lower gasket 120 against the first cover glass or pair of cover glasses to seal the sample chambers. In embodiments in which the clamping frame 130 includes the upper gasket 150, the clamping frame compresses the first cover glass or pair of cover glasses between the lower gasket 120 and the upper gasket along their perimeter to seal the sample chambers 107.

A method for forming a microfluidic testing device for aqueous sample containing biomaterials may include forming base member 101 via 3D printing; integrally forming lower gasket 120 thereon via 3D printing such that the lower gasket is an irremovable integral part of the base member, the base member defining a plurality of sample chambers each associated with fluid inlet and outlet ports to provide for fluid exchange; positioning one or more cover glasses on the base member; integrally forming upper gasket 150 on clamping frame 130 via 3D printing such that the upper gasket is an irremovable integral part of the clamping frame; and locking the clamping frame onto the base member such that the one or more cover glasses are sealed between the upper and lower gaskets.

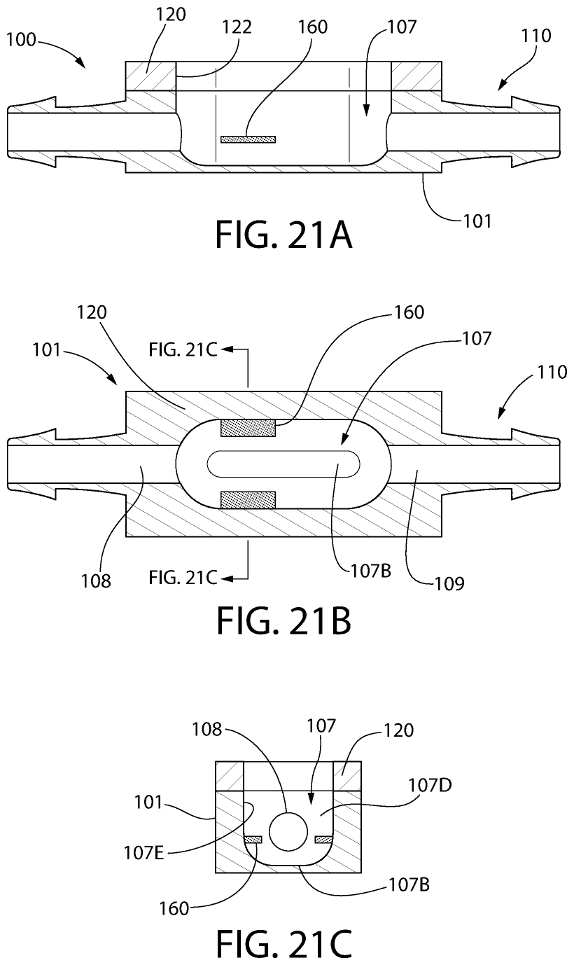

According to another aspect of the testing device 100, some or all of the sample chambers 107 may optionally further comprise include a pair of internal sample holders 160 as shown in FIGS. 21A-C. These holders allow solid biomaterial substrates (e.g., enamel blocks, dentin, and other dental materials as some non-limiting example) to be easily slid-in and restrict their movement for testing and restricts their potential movement within the sample chambers. The sample holders may be incorporated into and flank the transverse long sidewalls 107E of the chambers. In some non-limiting embodiments, the sample holders may have a length equal to or less than one-half the length of the sample chambers. Sample holders 160 extend inwards from each sidewall and are spaced above the bottom wall 107B of each chamber 107. The sample holders 160 may be arranged in opposing pairs which do not contact each other being spaced apart as shown. Sample holders 160 may be disposed in the lower half of each sample chamber 107 if provided to allow for the height of the solid samples. The sample holders may be discrete components which are attached to the internal walls of the sample chambers 107 by any suitable method, and in some embodiments may be 3D printed into the chambers. The sample holders may of course be omitted if no solid substrates are to be tested and analyzed.

In some embodiments, the base member 101 and clamping frame 130 may be formed of a suitable polymeric material. With exception of the cover glass(es) 102, all other parts of the microfluidic testing device 100 previously described herein may be formed by 3D printing, injection molding, a combination thereof, or other suitable fabrication techniques. The 3D printing technique allows precise control over the deposition of material and dimensional tolerances, as well as advantageously avoiding the need for injection molds.

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertains, and these aspects and modifications are within the scope of the invention and described and claimed herein.

1. A microfluidic device for testing aqueous laboratory samples, the device comprising:
a longitudinal axis;
an elongated base member extending along the longitudinal axis and defining a first outer surface, an opposite second outer surface, and a plurality of sample chambers;
a resiliently deformable first gasket disposed on the first outer surface, the first gasket comprising a plurality of openings each corresponding to a respective one of the sample chambers;
at least a first cover glass disposed on the first gasket and enclosing the openings; and
a peripheral clamping frame disposed on the first cover glass and comprising a plurality of resiliently flexible locking protrusions;
wherein the locking protrusions are configured to form a mechanical coupling with the base member and compress the first cover glass between the clamping frame and first gasket to seal the sample chambers.

2. The device according to claim 1, wherein each of the locking protrusions are configured to detachably and lockingly engage the second outer surface of the base member.

3. The device according to claim 1, wherein each of the locking protrusions are cantilevered structures elongated in a direction transverse to the longitudinal axis and comprise a hooked end which engages the second outer surface of the base member.

4. The device according to claim 3, wherein the plurality of locking protrusions comprise:
at least one locking protrusion which engages a first longitudinal side of the base member;
at least one locking protrusion which engages an opposite second longitudinal side of the base member;
at least one locking protrusion which engages a first lateral side of the base member; and
at least one locking protrusion which engages a second lateral side of the base member.

5. (canceled)

6. The device according to claim 1, wherein the clamping frame comprises an elongated central window which exposes the first cover glass providing a line of sight into each of the sample chambers.

7. The device according to claim 1, wherein the first gasket is integrally formed on the first outer surface of the base member being an irremovable permanent part of the base member.

8. The device according to claim 1, wherein the first gasket comprises an outwardly open first recessed area, the first cover glass being disposed in the first recessed area.

9. The device according to claim 1, further comprising a second gasket disposed between the first cover glass and the clamping frame, wherein the second gasket is integrally formed on an underside of the clamping frame being an irremovable permanent part of the clamping frame.

10. (canceled)

11. The device according to claim 9, wherein the second gasket comprises an elongated central window which exposes the first cover glass providing a line of sight into each of the sample chambers.

12. The device according to claim 9, further comprising a second cover glass disposed between the first gasket and the second gasket.

13. The device according to claim 12, wherein the second gasket comprises a first segment engaging the first cover glass and a discrete second segment engaging the second cover glass, the first and second segments separated by a longitudinal gap.

14. (canceled)

15. (canceled)

16. The device according to claim 1, wherein each of the sample chambers has an open top extending through the first outer surface and a closed bottom adjacent to the second outer surface.

17. (canceled)

18. (canceled)

19. (canceled)

20. A microfluidic system for testing aqueous laboratory samples, the system comprising:
a base member comprising a longitudinal axis, a plurality of sample chambers recessed into a first outer surface of the base member, and an integral resiliently deformable first gasket formed on the first outer surface;
each of the sample chambers comprising an inlet port and an outlet port defining a flow path through each of the sample chambers for introducing and extracting a fluid;
the first gasket comprising a plurality of openings each corresponding to a respective one of the sample chambers;
a first cover glass and a second cover glass each disposed on the first gasket and enclosing the openings;
a peripheral clamping frame comprising an integral second gasket formed on an underside thereof, the second gasket engaging the first and second cover glasses, the clamping frame further comprising a plurality of resiliently flexible locking protrusions;
wherein the locking protrusions are configured to form a mechanical coupling with the base member and compress the first cover glass between the first and second gaskets to seal the sample chambers.

21. The system according to claim 20, wherein each of the locking protrusions are configured to detachably and lockingly engage a second outer surface of the base member opposite the first outer surface.

22. The system according to claim 21, wherein each of the locking protrusions are cantilevered structures elongated in a direction transverse to the longitudinal axis and comprise a hooked end which engages the second outer surface of the base member.

23. The system according to claim 20, wherein the clamping frame and second gasket each comprise an elongated central window which exposes the first and second cover glasses providing a line of sight into each of the sample chambers.

24. The system according to claim 20, wherein the first cover glass is disposed in an outwardly open first recessed area of the first gasket, and the second cover glass is disposed in an outwardly open second recessed area of the first gasket, the first gasket comprising a partition wall which separates the first and second recessed areas.

25. The system according to claim 24, wherein the second gasket comprises a first segment engaging the first cover glass and a discrete second segment engaging the second cover glass, the first and second segments separated by a longitudinal gap receiving a pair of spacers formed on an underside of the clamping frame.

26. (canceled)

27. (canceled)

28. (canceled)

29. The system according to claim 20, wherein at least one of the sample chambers comprises a pair of sample holders configured to support a solid substrate sample, wherein the base member further comprises a plurality of hose barbs protruding outward from opposing longitudinal sides of the base member, each of the hose barbs configured for coupling to tubing and fluid coupled to one of the inlet and outlet ports of the base member.

30. (canceled)

31. (canceled)

32. A method for assembling a microfluidic device for testing aqueous laboratory samples comprising:
providing an elongated base member comprising a longitudinal axis, a plurality of sample chambers recessed into a first outer surface of the base member, and a resiliently deformable first gasket disposed on the first outer surface;
positioning at least a first cover glass on the first gasket;
positioning a clamping frame over the first cover glass;
slideably engaging a plurality of resiliently flexible locking protrusions of the clamping frame with the base member, the locking protrusions being in a deflected outward position; and
lockingly engaging the locking protrusions with the base member, the locking protrusions moving to an undeflected inward position;
wherein the clamping frame compresses the first cover glass onto first gasket to seal the sample chambers.

33.-38. (canceled)
